(19) United States
(12) Patent Application Publication
(10) Pub. No.: US 2024/0086364 A1
(43) Pub. Date: Mar. 14, 2024

(54) METHOD AND SYSTEM FOR TRANSLATING A DATA STREAM

(71) Applicant: Carl Zeiss Microscopy GmbH, Jena (DE)

(72) Inventor: Christian Andritzky, Jena (DE)

(73) Assignee: Carl Zeiss Microscopy GmbH, Jena (DE)

(21) Appl. No.: 18/238,200

(22) Filed: Aug. 25, 2023

(30) Foreign Application Priority Data
Sep. 8, 2022 (DE) D102022122836.3

(51) Int. Cl. G06F 16/14; G06F 16/16; G06F 16/182

(52) U.S. Cl. CPC G06F 16/148; G06F 16/162; G06F 16/1827

(57) ABSTRACT

The application relates to a computer-implemented method for providing data to a client. The method comprises monitoring read access operations on a file by the client. The file is provided as a network data stream by a network node. The client is configured to receive files only via a searchable file-based data stream. The method further comprises transmitting a network data stream containing the file to the client, the network data stream not being searchable, and translating the network data stream into a searchable file-based data stream on the basis of the read access operations.

### CROSS-REFERENCE TO RELATED PATENT APPLICATION DATA

This application claims priority from German patent application no. DE 10 2022 122 836.3 filed on Sep. 8, 2022, which is incorporated herein by reference in its entirety.

### TECHNICAL FIELD

The application relates to the translation of a network-based data stream into a file-based data stream.

### BACKGROUND

Older software solutions that continue to be used, in particular in industrial and scientific fields, are often configured in such a way that they expect input data to be in the form of locally stored data, i.e. as file-based data streams from a local permanent or removable memory. By way of example, older software for viewing and processing microscope images expects the microscope images to be in the form of data stored locally on the hard disk. Today, however, these data are often on a network and available to the older software solution not as a file-based data stream but rather as a network-based data stream. However, depending on the network protocol used, network-based data streams, in contrast to file-based data streams, are not searchable or are searchable only using read access operations that have a different structure than read access operations on file-based data streams. Since older software solutions expect searchability in the form of file-based data streams, however, this can lead to errors or even crashes. One solution would be to temporarily store the file stored in the network on a local memory in such cases. Depending on the size of the file and the bandwidth of the network, however, this can lead to problems in any case or may be impossible. By way of example, image files delivered by microscope systems are often very large. Temporarily storing these image files locally can therefore lead e.g. to problems with the bandwidth of the network, or the image files may be too large to be able to be stored locally. Temporary local storage of such files is therefore not efficient.

Against this background, it is an aim of the present invention to efficiently lend network-based data streams the appearance of file-based data streams for older software solutions.

### SUMMARY OF THE INVENTION

To achieve this aim, the present invention provides a computer-implemented method for providing data to a client. The method comprises monitoring read access operations on a file by the client, the file being provided as a network data stream by a network node and the client being configured to receive files only via a searchable file-based data stream, transmitting a network data stream containing the file to the client, the network data stream not being searchable, and translating the network data stream into a searchable file-based data stream on the basis of the read access operations.

The invention also provides a computer-readable storage medium in order to achieve this aim. The computer-readable storage medium is configured to store instructions that, when executed by a computing apparatus having a processor, cause the processor to carry out the above computer-implemented method for providing data to a client.

### BRIEF DESCRIPTION OF THE FIGURES

Embodiments of the present invention are described below with reference to the appended figures, in which identical reference signs relate to identical elements.

FIG. 1 shows a flowchart for a computer-implemented method for providing data to a client according to embodiments of the present invention.

FIG. 2 shows a flowchart for buffer-storage aspects of the computer-implemented method for providing data to a client according to embodiments of the present invention.

FIG. 3 shows a network in which the method for providing data to a client is used according to embodiments of the present invention.

FIG. 4 shows a computing apparatus for carrying out the method for providing data to a client according to embodiments of the present invention.

It should be understood that the provision of these drawings is not intended to limit the disclosure of the present invention to the aspects shown in the figures. Rather, these drawings are provided in order to help to understand the present invention. A person skilled in the art will immediately understand that aspects of the present invention that are shown in one drawing can be combined with aspects from another drawing or that aspects shown in one figure can be omitted, without departing from the subject matter of the present invention.

### DETAILED DESCRIPTION

The text below describes a method that, based on a read access operation on a file by a client, converts a network data stream into a searchable file-based data stream. File is intended to be understood to mean any type of data resource, as will be illustrated in more detail below. The read access operations by the client assume a file that can be provided to the client via a file-based data stream. In actual fact, however, the file is provided via a network-based data stream. To allow access by the client despite this discrepancy, the method can adapt the read access operations by the client. Furthermore, the method can deal with the provision of the data by the network-based data stream in response to the read access operations in such a way that the provision of the data corresponds to that expected by the client in response to the read access operations on a file-based data stream. The method is transparent to the network data stream and the client in this case, i.e. the client and the network data stream do not notice the translation by the method. This general concept of the method will now be described in detail with reference to the figures.

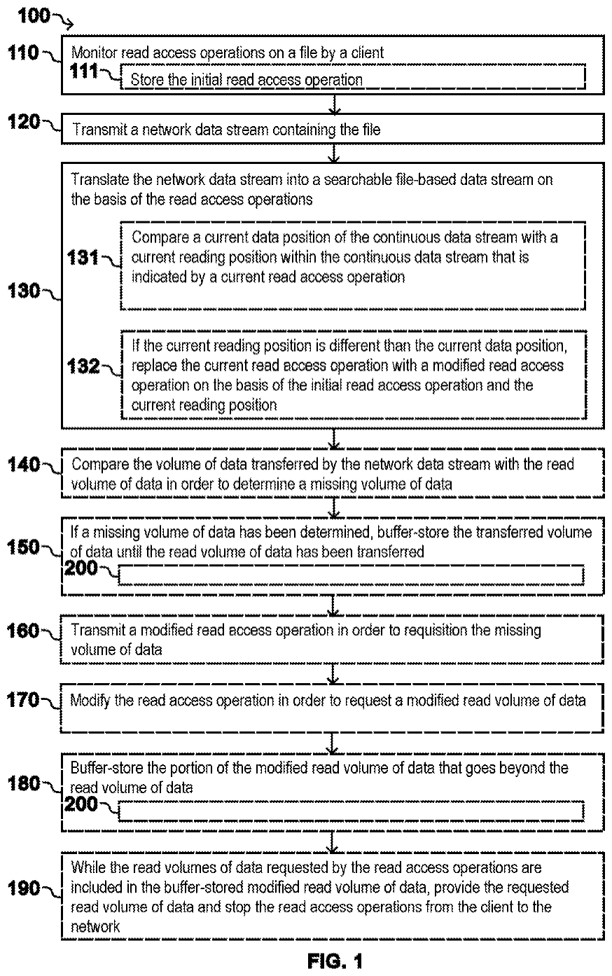

FIG. 1 shows a flowchart for a computer-implemented method 100 for providing data to a client. Optional steps of the method are indicated by dashed boxes in FIG. 1. The sequence of steps shown in FIG. 1 is merely illustrative and can be varied according to the demands on the translation of the network data stream into the file-based data stream.

In step 110, the method 100 monitors read access operations on a file by the client.

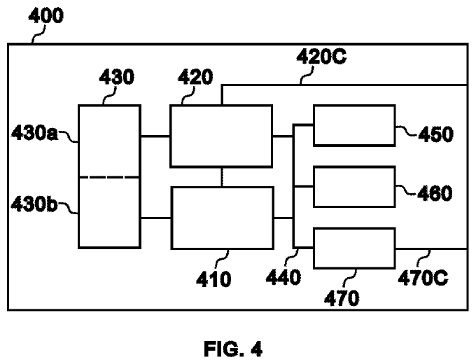

Within the context of this application, client denotes any computing apparatus that is capable of executing read access operations on a file provided by a network node of a network. An example of such a computing apparatus will be discussed below with reference to FIG. 4.

Within the context of this application, network node denotes any type of subscriber in a network that is configured to provide files in response to read access operations by the client. By way of example, the client may be a server or another client storing the file that the read access operations access. If the network node is a client, it may be configured to provide the file by acting as a server for the read access operations. It should be understood in this case that provision by a network node is intended to be understood to mean both provision by a single network node and provision by multiple network nodes. By way of example, the file may be stored in a manner distributed over multiple network nodes.

The file accessed by the read access operations by the client may be any type of data resource containing information that the client needs for a reproduction or other, non-altering processing. By way of example, the data resource may be a microscope image or a microscope image conditioned by the network node ad hoc in response to the read access operation. Examples of such conditioning would be composition or rendering of the microscope image by the network node. It should be understood that images or conditioned images, in particular microscope images, are merely illustrative. More generally, the file or the data resource may be a file stored on one or more network nodes, a conditioned data resource, a resource provided by the network node from other sources to respond to the read access operation, such as e.g. from a database or by download from a further network node, or any other type of data resource that provides the information needed by the client.

Within the context of this application, read access denotes any access to a file. A read access operation is accordingly an access operation on the data resource in order to display the data resource or use it otherwise in a non-altering manner. In order to access a file, read access operations identify at least one from the file itself and an area of the file that the client accesses. Method 100 accordingly monitors read access operations by the client in order to establish which file and/or which areas of the file the client accesses.

The file that the client accesses using the read access operations is provided as a network data stream by a network node. The network data stream begins to provide the file to the client continuously from an initial reading position, which is defined by an initial read access operation by the client. However, the client is configured to receive files only via a searchable file-based data stream. In other words, the client expects the file that it accesses using its read access operations to be in the form of a locally stored file in which the client can skip with its read access operations, i.e. in which the client can move the reading position both forward and backward as seen from the first byte of the file. Against this background, the “searchable” attribute of the file-based data stream is intended to be understood to mean that the reading position can be moved freely forward or backward in the file after an initial read access operation. As a result of the network data stream transferring the file only continuously from the initial reading position, said network data stream is not searchable in the sense of a file-based data stream.

In order to search the network data stream, i.e. to vary the reading position as desired, the client would need to restart the network data stream with a read access operation, i.e. to submit a read access operation that identifies both the file and the reading position. Since, when the reading position is changed for a searchable data stream, the file does not need to be identified again after the initial read access operation, the client will not identify the file again for subsequent read access operations, but only the reading position. Such a read access operation is not possible for the file provided as a network data stream, however, since data are provided only continuously and a read access operation that restarts the network data stream would also need to identify the file.

Since, as explained above, only the initial read access operation identifies the file regularly, step 110 can involve a step 111 in which the method 100 stores the initial read access operation on the file, in order to thus store the identification of the file.

In step 120, the method transmits the network data stream containing the file to the client in response to the read access operation. Since the network data stream is not searchable, the method 100 translates the network data stream into a searchable file-based data stream in step 130 on the basis of the read access operations by the client. In other words, the method 100 uses the translation to ensure that read access operations by the client that assume a searchable file-based data stream lead to the aforementioned restarting of the continuous network data stream, according to the current data position of the continuous network data stream.

For this purpose, step 130 can involve a step 131 in which the method 100 compares a current data position of the continuous network data stream with a current reading position within the continuous network data stream that is indicated by a current read access operation by the client. Accordingly, in step 131, the method 100 checks whether the continuously progressing data position of the network data stream corresponds to the position within the file that is requested by the client in its read access operation. If this is the case, it is not necessary for the method 100 to intervene, since the client obtains the data position that it expects. In this case, the method 100 can compare the current data position and the volume of data requested by the read access operation with a certain tolerance in step 131. If for example the continuous network data stream is at position or byte 524 288 in the file and the client is currently requesting position 655 360 to 917 504, the method 100 may decide that it is not necessary to translate. Step 131 of the method 100 therefore does not require an exact match.

Furthermore, step 130 can involve a step 132 in which the method replaces the current read access operation with a modified read access operation if the current reading position is different than the current data position. The modified read access operation can be based on the initial read access operation and the current reading position. The modified read access operation can therefore trigger the aforementioned restarting of the continuous network data stream, e.g. if the client wants to access a position within the file that is situated further forward as seen from the current data position or if the client wants to access a position within the file after the current data position. The modified read access operation can combine the identification of the file that was included in the initial read access operation with the currently requested reading position and can replace the read access operation by the client with the read access operation thus produced.

The continuous network data stream transfers data of a file from the data position of a read access operation, as already explained. Here, “continuous” denotes the fact that volumes of data are transferred from the data position to the end of the file. The speed of transfer does not have to be continuous in this case. Accordingly, there can be delays in the transfer of the network data stream. Read access operations by the client can request a read volume of data for the file, or a read volume of data can be defined per read access operation. By way of example, the client may expect a read volume of data of 512 kB. The continuous network data stream begins to transfer the 512 kB from the reading position, but falters and pauses when 256 kB of data have been transferred. Since the transfer of the read volume of data has begun and owing to the pause, the effect of this transfer from the point of view of the client is that of a completed transfer that has 256 kB missing. By contrast, although a file-based searchable data stream may also experience delays, file-based searchable data streams do not normally deliver part-read volumes of data, but rather deliver complete read volumes of data, the beginning of the transfer of the complete read volume of data being delayed, but no pauses occurring as soon as the transfer has begun.

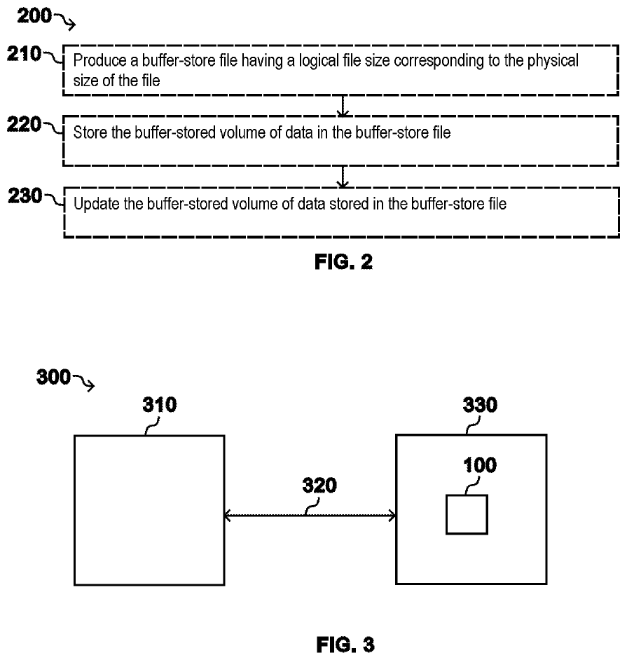

Since part-read volumes of data such as these are not expected by the client, the method 100 can involve a step 140 in which the method 100 compares a volume of data transferred by the network data stream with the read volume of data in order to determine a missing volume of data. If the method determines a missing volume of data in step 140, the method can buffer-store the transferred volume of data in a step 150 until the read volume of data has been transferred. In this case, the method 100 can buffer-store the transferred volume of data e.g. as discussed below with reference to FIG. 2. Moreover, the method can involve a step 160 in which the method 100 transmits a modified read access operation in order to requisition the missing volume of data. The modified read access operation can insist on identification of the file from the stored initial read access operation and a reading position determined on the basis of the missing read volume of data.

In order to keep down the volume of data transferred via the network, the method 100 can further modify read access operations by the client for this purpose. This may be significant in particular for incrementally regressive read access operations but also for progressive read access operations, since these can lead to repeated read access operations on the network data stream.

For this purpose, the method can involve a step 170 in which the method 100 modifies the read access operations in order to request a modified read volume of data. The modified read volume of data can be larger than the read volume of data. The portion of the modified read volume of data that goes beyond the read volume of data can be buffer-stored by the method 100 in a step 180. The method can e.g. buffer-store the portion of the modified read volume of data that goes beyond the read volume of data as discussed below with reference to FIG. 2. While the read volumes of data requested by the read access operations are included in the buffer-stored modified read volume of data, the method can finally provide the requested read volume of data to the client in a step 190. This allows the method 100 to stop the read access operations from the client to the network until the read volumes of data requested by the read access operations are no longer included in the buffer-stored modified read volume of data.

In summary, the method 100 allows in particular older clients not designed to receive files through network data streams to access such files without error by virtue of read access operations by the clients being adapted and if necessary volumes of data being buffer-stored.

FIG. 2 shows a flowchart for buffer-storage aspects of the method 100 of FIG. 1. As already mentioned, the method can buffer-store read volumes of data of the network stream, for example as part of step 150 or 180, in order to avoid errors due to part-read volumes of data or in order to avoid repeated data interchange via the network connection.

Accordingly, the method can involve, as part of step 150 or 180, a step 210 in which the method 100 produces a buffer-store file having a logical file size corresponding to the physical size of the file. This buffer-store file can be created by the method 100 once during a first buffer-storage, for example, and can be retained while the method 100 is running.

Further, the method can store the buffer-stored volume of data in the buffer-store file in step 220. Sections of the file that are not included in the buffer-stored file can be stored only logically, with the result that a physical file size of the buffer-store file corresponds to the size of the buffer-stored volume of data. By way of example, the sections that are stored only logically can be regarded as being stored physically with a standard value. In other words, these sections can be stored e.g. as a reference such that the positions that are stored only logically each assume the logic value “0” or “1”. The amount of storage physically used thus merely corresponds to the reference to the standard value. Thus, in step 220, the method 100 prevents the buffer-store file from becoming too large, which would otherwise be a problem in particular in the case of high-resolution and/or multidimensional images such as microscope images but also in the case of other file types. For this purpose, the method 100 can further involve the step 230, in which the method updates the buffer-stored volume of data stored in the buffer-store file. The updating in step 230 can involve erasing volumes of data that are no longer required from the buffer-stored file.

In summary, the steps in FIG. 2 accordingly ensure that the method 100 can buffer-store volumes of data without buffer-storing excessively large volumes of data. In particular, the whole file provided by the network data stream is not buffer-stored.

FIG. 3 shows a network 300 in which the method 100 is used. In this regard, FIG. 3 shows a network node 310, a network connection 320 and a client 330. More detailed examples of the network node 310 and the client 330 are described below with reference to FIG. 4.

The network connection 320 is the logical connection via which the network data stream discussed with reference to FIG. 1 is transferred. The physical connection behind the network connection 320 may be either wireless or wired, depending on the capabilities of the client 330 and the network node 310.

As shown, the method 100 is carried out on the client 330. In other words, the method 100 on the client 330 monitors the read access operations directed to a data resource on the network node 310 and monitors the volumes of data received via the network connection 320 in order to modify the read access operations by the client and the volumes of data transferred by the network node 310 transparently to the client 330 and the network node 310 in such a way that the client 330 expecting searchable file-based data streams can interact with the network data stream without error.

FIG. 4 shows a computing apparatus 400 that can be used either as a network node 310 or as a client 330. The computing apparatus 400 is accordingly configured to perform the method 100. The computing apparatus 400 can comprise a processor 410, a graphics processing unit (general processing unit, GPU) 420, a main memory 430, a bus 440, a memory 450, a removable memory 460 and a communication interface 470.

The processor 410 may be any type of single-core or multicore processing unit that uses a reduced instruction set (RISC) or a complex instruction set (CISC). Exemplary RISC processing units comprise ARM-based cores or RISC V-based cores. The illustrative CISC processing units include x86-based cores or x86-64-based cores. The processor 410 may further be an application-specific integrated circuit (ASIC) or a field-programmable gate array (FPGA) that is specifically tailored or programmed to perform the method 100. The processor 410 can execute commands that cause the computing apparatus 400 to perform the method 400. The processor 410 may be connected directly to one of the components of the computing apparatus 400 or may be connected directly to the memory 430, the GPU 420 and the bus 440.

The GPU 420 may be any type of processing unit that is optimized to process graphics-related instructions or more generally to process instructions in parallel. As such, the GPU 420 can carry out part or all of the method 100 in order to facilitate fast parallel processing of instructions for the method. It should be noted that the processor 410 is able, in some embodiments, to specify that the GPU 420 does not need to execute any instructions for the method 100. The GPU 420 may be connected directly to one of the components of the computing apparatus 100 or may be connected directly to the processor 410 and the memory 430. The GPU 420 may also be connected to a display via the connection 420C. In some embodiments, the GPU 420 may also be connected to the bus 440.

The memory 430 can be any type of fast memory that allows the processor 410 and the GPU 420 to store commands for fast access during processing of the commands and to buffer-store and buffer data. The memory 430 can be a unified memory that is connected both to the processor 410 and to the GPU 420 and allows the memory 430 to be assigned to the processor 410 and to the GPU 420 as needed. Alternatively, the processor 410 and the GPU 420 may be connected to separate processor memories 430a and GPU memories 430b.

The memory 450 may be a storage device that allows program instructions and other data to be stored. For example, the memory 450 may be a hard disk drive, a solid state storage apparatus (solid state disk, SSD) or another type of nonvolatile memory. The memory 450 can be used to store instructions of the method 100 or buffer-stored volumes of data of the network data stream, for example.

The removable memory 460 may be a storage device that can be connected to the computing apparatus 400 removably. Examples are a digital versatile disc (DVD), a compact disc (CD), a universal serial bus (USB) storage device, such as an external SSD, or a magnetic tape. The removable memory 440 can be used for example in order to store the instructions of the method 400. Depending on the demands on the computing apparatus 400, the removable memory 460 can also be omitted.

The memory 450 and the removable memory 460 may be connected to the processor 410 via the bus 440. The bus 440 can be any type of bus system that allows the processor 410 and optionally the GPU 420 to communicate with the storage device 450 and the removable memory 460. By way of example, the bus 440 can be a peripheral component interconnect express (PCIe) bus or a serial AT attachment (SATA) bus.

The communication interface 470 can allow the computing apparatus 400 to use the connection 470C to communicate with external devices, either directly or via a network. By way of example, the communication interface 470 can allow the computing apparatus to connect to a wired or wireless network, such as e.g. Ethernet, WiFi or a controller area network (CAN) bus. By way of example, the computing apparatus 400 can use the connection 470C to receive the network data stream or to transfer the read access operations to the network node 310 if the computing apparatus is used as a client 330. The communication interface can also be a USB port or a serial port in order to allow direct communication with an external device.

The invention is further illustrated by the examples below.

In one example, a computer-implemented method for providing data to a client comprises monitoring read access operations on a file by the client, the file being provided as a network data stream by a network node and the client being configured to receive files only via a searchable file-based data stream, transmitting a network data stream containing the file to the client, the network data stream not being searchable, and translating the network data stream into a searchable file-based data stream on the basis of the read access operations.

In one example, the network data stream can be a continuous data stream that continuously transfers the file continuously from an initial reading position within the file that has been indicated by an initial read access operation.

In one example, the monitoring can comprise storing the initial read access operation and the translating can comprise: comparing a current data position of the continuous data stream with a current reading position within the continuous data stream that is indicated by a current read access operation; if the current reading position is different than the current data position, replacing the current read access operation with a modified read access operation on the basis of the initial read access operation and the current reading position.

In one example, only the initial read access operation identifies the file.

In one example, the read access operations can request a read volume of data for the file or the read volume of data may be defined per read access operation, and the method can further comprise: comparing the volume of data transferred by the network data stream with the read volume of data in order to determine a missing volume of data; if a missing volume of data has been determined, buffer-storing the transferred volume of data until the read volume of data has been transferred.

In one example, the method can further comprise transmitting a modified read access operation in order to requisition the missing volume of data.

In one example, the read access operations can request a read volume of data for the file or the read volume of data may be defined per read access operation, and the method can further comprise: modifying the read access operations in order to request a modified read volume of data, the modified read volume of data being larger than the read volume of data, buffer-storing the portion of the modified read volume of data that goes beyond the read volume of data, and, while the read volumes of data requested by the read access operations are included in the buffer-stored modified read volume of data, providing the requested read volume of data and stopping the read access operations from the client to the network.

In one example, the buffer-storage steps can involve: producing a buffer-store file having a logical file size corresponding to the physical size of the file; and storing the buffer-stored volume of data in the buffer-store file, sections of the file that are not included in the buffer-stored file being stored only logically, with the result that a physical file size of the buffer-store file corresponds to the size of the buffer-stored volume of data.

In one example, the buffer-storage steps can further involve: updating the buffer-stored volume of data stored in the buffer-store file, the updating involving erasing volumes of data that are no longer required from the buffer-stored file.

In one example, sections that are stored only logically can be regarded as being stored physically with a standard value.

In one example, a computer-readable storage medium is configured to store instructions that, when executed by a computing apparatus having a processor, cause the processor to carry out the method according to one of the preceding examples.

The description hereinabove has been provided in order to illustrate a method for providing data to a client by translating a network data stream into a file-based data stream. It should be understood that the description is not intended in any form to limit the scope of the invention to the exact embodiments that have been discussed in this description. Rather, a person skilled in the art will see that embodiments can be combined, modified or simplified without departing from the scope of the invention as defined by the claims that follow.

1. A computer-implemented method for providing data to a client, comprising:
monitoring read access operations on a file by a client, the file being provided as a network data stream by a network node and the client being configured to receive files only via a searchable file-based data stream;
transmitting a network data stream containing the file to the client (330), the network data stream not being searchable; and
translating the network data stream into a searchable file-based data stream on the basis of the read access operations.

2. The computer-implemented method as claimed in claim 1, wherein the network data stream is a continuous data stream that continuously transfers the file continuously from an initial reading position within the file that has been indicated by an initial read access operation.

3. The computer-implemented method as claimed in claim 2,
wherein the monitoring comprises storing the initial read access operation; and
wherein the translating comprises:
comparing a current data position of the continuous data stream with a current reading position within the continuous data stream that is indicated by a current read access operation;
if the current reading position is different than the current data position, replacing the current read access operation with a modified read access operation on the basis of the initial read access operation and the current reading position.

4. The computer-implemented method as claimed in claim 2, wherein only the initial read access operation identifies the file.

5. The computer-implemented method as claimed in claim 1, wherein:
the read access operations request a read volume of data for the file or the read volume of data is defined per read access operation; and
the method further comprises:
comparing the volume of data transferred by the network data stream with the read volume of data in order to determine a missing volume of data;
if a missing volume of data has been determined, buffer-storing the transferred volume of data until the read volume of data has been transferred.

6. The computer-implemented method as claimed in claim 5, wherein the method further comprises:
transmitting a modified read access operation in order to requisition the missing volume of data.

7. The computer-implemented method as claimed in claim 1, wherein:
the read access operations request a read volume of data for the file or the read volume of data is defined per read access operation; and
the method further comprises:
modifying the read access operations in order to request a modified read volume of data, the modified read volume of data being larger than the read volume of data;
buffer-storing the portion of the modified read volume of data that goes beyond the read volume of data; and
while the read volumes of data requested by the read access operations are included in the buffer-stored modified read volume of data, providing the requested read volume of data and stopping the read access operations from the client to the network.

8. The computer-implemented method as claimed in claim 7, wherein the buffer-storage steps involve:
producing a buffer-store file having a logical file size corresponding to the physical size of the file; and
storing the buffer-stored volume of data in the buffer-store file, sections of the file that are not included in the buffer-stored file being stored only logically, with the result that a physical file size of the buffer-store file corresponds to the size of the buffer-stored volume of data.

9. The computer-implemented method as claimed in claim 8, wherein the buffer-storage steps further involve:
updating the buffer-stored volume of data stored in the buffer-store file, the updating involving erasing volumes of data that are no longer required from the buffer-stored file.

10. The computer-implemented method as claimed in claim 8, wherein sections that are stored only logically are regarded as being stored physically with a standard value.

11. A computer-readable storage medium, configured to store instructions that, when executed by a computing apparatus having a processor, cause the processor to carry out the method as claimed in claim 1.
